(19) United States
(12) Patent Application Publication
(10) Pub. No.: US 2014/0258415 A1
(43) Pub. Date: Sep. 11, 2014

(54) NETWORK COMMUNICATIONS VIA PEER NETWORK CONNECTIONS

(71) Applicants: Israel L'Heureux, Monaco (MC); Mark D. Alleman, Portland, OR (US)

(72) Inventors: Israel L'Heureux, Monaco (MC); Mark D. Alleman, Portland, OR (US)

(21) Appl. No.: 13/168,989

(22) Filed: Jun. 26, 2011

(51) Int. Cl. G06F 15/16

(52) U.S. Cl. 709/205

(57) ABSTRACT

Embodiments for network communications via peer network connections are disclosed. Network communications systems and methods may identify a trusted group of peer devices associated with a computing device. The peer devices may be linked with the computing device via a peer discovery LAN. Connection status information may be received for each WAN connection of each peer device. One or more peer devices of the trusted group may be selected as gateways to the WAN based on the connection and/or power status information. One or more requests for one or more network resources may be generated at the computing device. The one or more requests may be sent to the peer devices selected as gateways to be forwarded via the WAN to one or more remote servers hosting the network resources. One or more responses to the requests may be received from remote servers via the peer devices selected as gateways.

### BACKGROUND

Computing devices communicate with each other via a variety of wired and/or wireless communications links. For example, some mobile devices may communicate via a near-field wireless communications link such as Wi-Fi or Bluetooth, a far-field wireless communications link such as a 3G or 4G cellular protocol, and a wired communications link such as via a tethered connection to a personal computer. These communications links may support different data transfer rates, may be associated with different financial costs for their use, and may utilize different resources of a computing device such as power, memory, and processing resources. Therefore, a number of options exist for a computing device to communicate with other computing devices in a network.

### SUMMARY

Embodiments for network communications via peer network connections are disclosed. Network communications systems and methods may identify a trusted group of peer devices associated with a computing device. The peer devices may be linked with the computing device via a peer discovery LAN. Connection status information may be received for each WAN connection of each peer device and/or power status information may be received for each peer device. One or more peer devices of the trusted group may be selected as gateways to the WAN based on the connection and/or power status information. One or more requests for one or more network resources may be generated at the computing device. The one or more requests may be sent to the peer devices selected as gateways to be forwarded via the WAN to one or more remote servers hosting the network resources. One or more responses to the requests may be received from remote servers via the peer devices selected as gateways. Claimed subject matter, however, is not limited by this summary as other implementations may be disclosed by the written description and associated drawings.

### BRIEF DESCRIPTION OF DRAWINGS

FIG. 1 is a schematic diagram depicting an example network communications system according to one disclosed embodiment.

FIG. 2 is a flow diagram depicting an example method for network communications via peer network connections according to one disclosed embodiment.

FIG. 3 is a flow diagram depicting another example method for network communications via peer network connections according to one disclosed embodiment.

FIG. 4 is a schematic diagram depicting an example graphical user interface of a computing device according to one disclosed embodiment.

FIG. 5 is a schematic diagram depicting a detailed view of an example computing device according to one disclosed embodiment.

### DETAILED DESCRIPTION

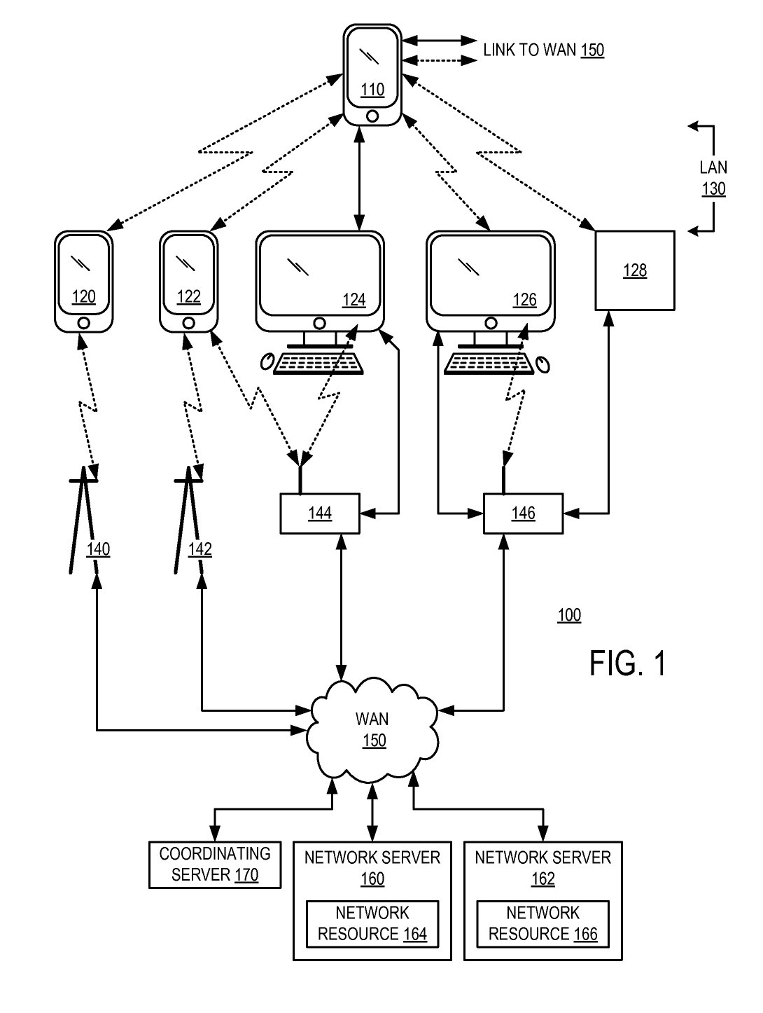

FIG. 1 is a schematic diagram depicting an example network communications system 100 according to one disclosed embodiment. In FIG. 1, a trusted group of peer devices (e.g., peer devices 120, 122, 124, 126, 128, etc.) associated with a computing device 110 may be identified. The peer devices may be linked with computing device 110 via a peer discovery local area network (LAN) 130 over wired and/or wireless communications links. Status information including connection status information, power status information, and/or device status information may be received for each peer device. One or more peer devices of the trusted group may be selected as gateways to WAN 150 based on the status information. One or more requests for one or more network resources 164, 166, etc. may be generated at computing device 110. Network resources 164, 166, etc. may include a webpage, a portion of a webpage, a file such as an image, a video, text, etc., a portion of a file, a computer program, or portion of a computer program, among other suitable network resources. The one or more requests may be sent to the peer devices selected as gateways to be forwarded via WAN 150 to one or more remote servers 160, 162, etc. hosting network resources 164, 166, etc. One or more responses to the requests may be received from the remote servers 160, 162, etc. via the peer devices selected as gateways.

WAN 150 may comprise, for example, the Internet, a cellular wireless network backbone, a combination thereof, or a portion thereof. Peer devices 120-128 may be connected with WAN 150 via one or more wired and/or wireless communication links. In FIG. 1, wired communication links are depicted by arrows having solid lines, and wireless communication links are depicted by arrows having broken lines. For example, peer device 120 is a mobile device that may communicate with WAN 150 via at least a wireless communications link and a wireless base station 140. For example, the wireless communications link may be a 3G or 4G wireless communications link supporting wireless communications according to a wireless protocol such as LTE, WiMAX, CDMA, TDMA, OFDMA, GSM, UMTS, or other suitable wireless protocol. Computing device 110 is depicted communicating with peer device 120 via a wireless communications link of peer discovery LAN 130. As one example, computing device 110 may communicate with peer device 120 via a near-field wireless communications link such as Wi-Fi, Bluetooth, infrared or other suitable near-field wireless protocol.

Peer device 122 is also a mobile device that may communicate with WAN 150 via at least a wireless communications link and a wireless base station 142. Alternatively or additionally, peer device 122 may communicate with WAN 150 via another wireless communications link and router 144. Router 144 may be a wireless router, for example. Wireless base station may support a far-field wireless communications link such as a 3G or 4G wireless communications link, and router 144 may support a near-field wireless communications link such as Wi-Fi, Bluetooth, infrared, etc. Computing device 110 is depicted communicating with peer device 122 via a near-field wireless communications link of peer discovery LAN 130.

Peer devices 124 and 126, for example, are personal computers, such as a laptop computer, desktop computer, etc. that may communicate with WAN 150 via routers 144 and 146, respectively, over wired and/or wireless communications links. Computing device 110 is depicted communicating with peer device 124 via a wired communications link. As one example, this wired communications link may include a wired tether or dock that enables a mobile device to be synced with and/or obtain power from a peer device 124. Computing device 110 is depicted communicating with peer device 126 via a wireless communications link.

Beyond the mobile device and personal computer peer devices 120-126, peer device 128 may take the form of any suitable electronic device supporting communications with WAN 150 such as, for example, a cable television box, game console, media player, router, server device, etc. Peer device 148 may communicate with WAN via router 146, for example. Routers 144 and 146 may include or take the form of wired and/or wireless routers.

Peer devices 120-128 may communicate with WAN 150 via common intermediate devices. In FIG. 1, for example, peer devices 122 and 124 are shown communicating with WAN 150 via the same router 144, and peer devices 126 and 128 are shown communicating with WAN 150 via the same router 146. It is to be appreciated that peer devices may communicate with WAN 150 via any suitable number and/or type of intermediate device that may support communications for some or all of the peer devices of a trusted group. It is also to be appreciated that peer devices may communicate with WAN 150 without directing communications through intermediate devices 140-146.

As described in greater detail herein, computing device 110 may communicate with WAN 150 via one or more of peer devices 120-128 over peer discovery LAN 130. Additionally or alternatively, computing device 110 may communicate with WAN 150 via wired and/or wireless communication links without directing communications through peer devices 120-128. For example, computing device 110 may communicate with WAN 150 via one or more wireless base stations and/or routers such as previously described intermediate devices 140-146.

In some implementations, coordinating server 170 may be provided that is configured to receive status information including connection status information, power status information, and/or device status information from computing device 110 and peer devices 120-128. Coordinating server 170 may be configured to select one or more peer devices to serve as gateways for computing device 110 to WAN 150 based on the status information. However, in some implementations, computing device 110 may be configured to receive status information and select one or more peer devices to serve as gateways for computing device 110 to WAN 150 based on the status information. Hence, coordinating server 170 may be omitted in some implementations.

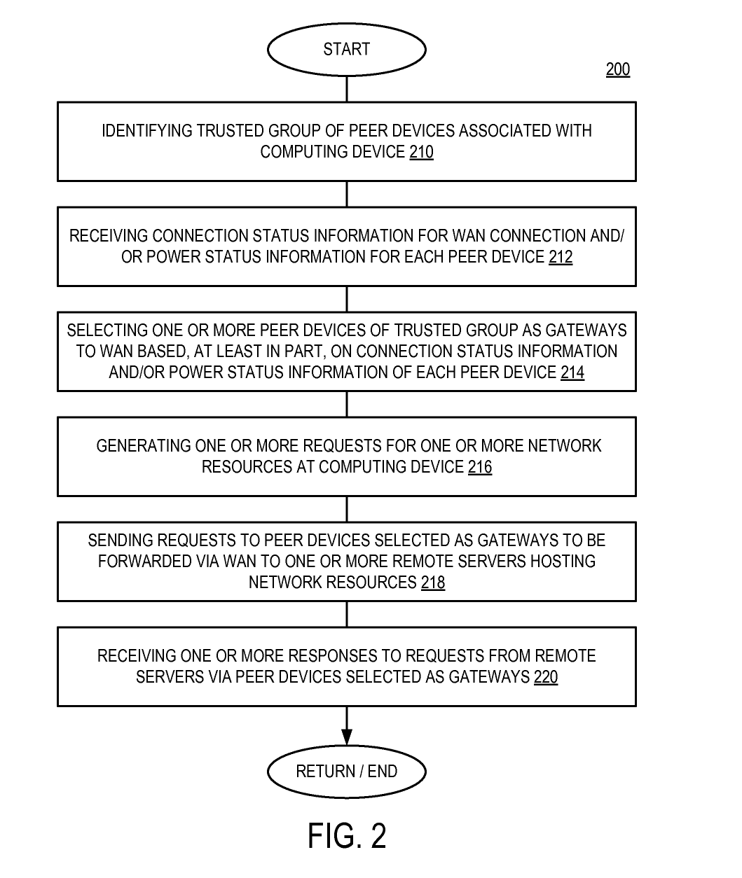

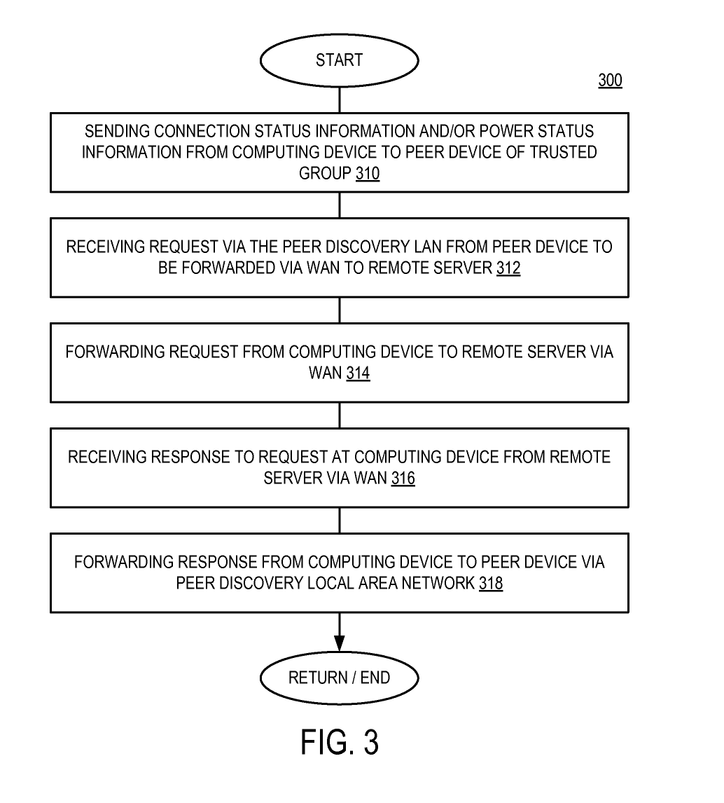

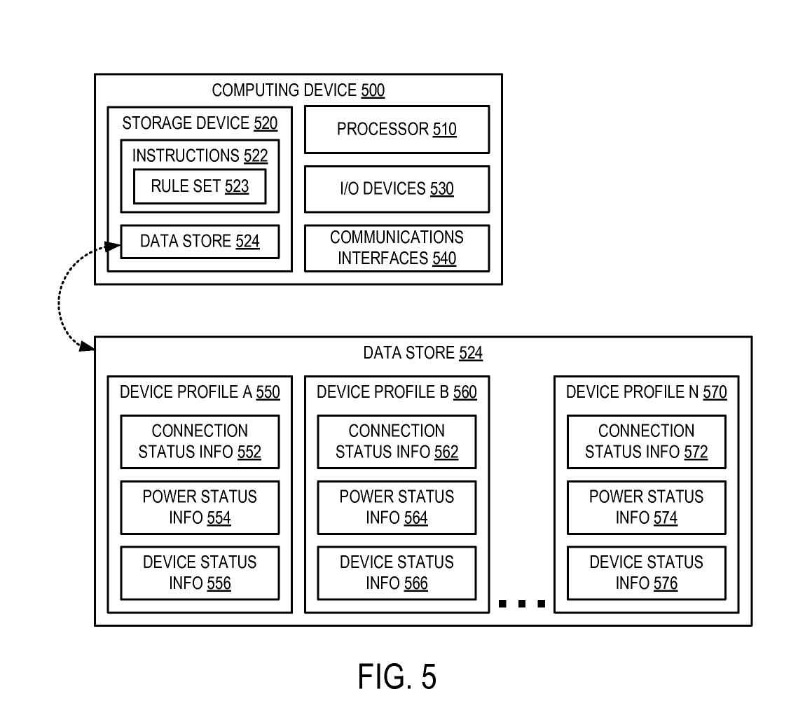

From the perspective of peer devices 120-128, computing device 110 may be a peer device of a trusted group. Furthermore, peer devices 120-128, server devices 162 and 164, and coordinating server 170 in addition to computing device 110 may include or take the form of a computing device described in greater detail with reference to FIG. 5. A computing device may include one or more processors, and a storage device having instructions stored thereon that are executable by the one or more processors to perform the methods, processes, and functions described herein, for example, with reference to FIGS. 2 and 3.

FIG. 2 is a flow diagram depicting an example method 200 for network communications via peer network connections according to one disclosed embodiment. As a non-limiting example, method 200 may be performed by example network communications system 100 of FIG. 1. Accordingly, method 200, or portions thereof may be implemented by one or more processors of one or more devices executing instructions.

At 210, method 200 includes identifying a trusted group of peer devices associated with a computing device. The peer devices may each be linked with the computing device via a peer discovery local area network. As one example, identifying the trusted group of peer devices associated with the computing device may include receiving, via a selector displayed on a graphical user interface of the computing device, user input either to join the trusted group by opting-in to joining or to join the trusted group by automatically joining available groups. Alternatively or additionally, identifying the trusted group of peer devices associated with the computing device may include identifying a user account that spans each peer device of the trusted group. For example, a user may establish a user account (e.g., as the device owner or as a device user) on two or more devices including the computing device, and one or more peer devices.

At 212, method 200 includes receiving connection status information for each wide area network connection of each peer device. The connection status information for a wide area network connection of a peer device of the trusted group may indicate a performance parameter of the wide area network connection. The performance parameter may include a round-trip time for communications between the peer device and a remote server of the one or more remote servers via the wide area network. Alternatively or additionally, the performance parameter may include an available bandwidth (e.g., data transfer rate) for communications between the peer device and the remote server via the wide area network. The connection status information for a WAN connection of a peer device may indicate a connection type of the WAN connection such as wired or wireless, protocol type, etc. The connection status information for a WAN connection of a peer device may indicate a financial cost associated with communications between the peer device and a remote server via the WAN. At 212, method 200 may alternatively or additionally include receiving power status information and/or device status information for each peer device of the trusted group. The power status information may indicate a battery charge state (e.g., % charge) and/or an external power connection state (e.g., plugged in or unplugged) of a peer device, for example. The device status information may indicate processor availability and/or memory availability, for example. The status information, including connection status information, power status information, and/or device status information may be received from peer devices by the computing device and/or by a coordinating server in response to requests sent to the peer devices.

At 214, method 200 includes selecting one or more peer devices of the trusted group as gateways to the WAN based, at least in part, on the connection status information of each peer device. Alternatively or additionally, at 214, the method includes selecting one or more peer devices of the trusted group as gateways to the WAN based, at least in part, on the power status information and/or device status information of each peer device. Selecting one or more peer devices at 214 may include balancing the one or more requests among the one or more peer devices selected as gateways based on one or more of the connection status information, power status information, and/or device status information. In some implementations, the computing device may perform the selecting of the peer devices. In some implementations, a coordinating server may perform the selecting of the peer devices, and may send a selection indicator to the computing device. The computing device may receive the selection indicator from the coordinating server indicating one or more selected peer devices.

In some implementations, peer devices may be weighted for selection according to a rule set. The rule set may define one or more rules to be applied to the selection of peer devices based on one or more of the connection status information, power status information, and/or device status information. As a non-limiting example, peer devices having a connection status indicating a faster round-trip time or greater bandwidth may be weighted for selection over peer devices having a slower round-trip time or lesser bandwidth. Accordingly, peer devices may be selected to maximize, optimize, or otherwise substantially increase the data transfer rate between the computing device and the WAN. Alternatively or additionally, peer devices providing lower latency connections to the WAN may be selected as gateways for requesting and receiving smaller data items; and peer devices providing higher bandwidth connections to the WAN may be selected as gateways for requesting and receiving larger data items. Peer devices may each measure their latency with servers across the WAN by measuring round trip time on outbound connections, and these round trip times may be communicated to the computing device and compared and weighted with other factors to select peer devices for use as gateways for outbound connections over the WAN. As another indication of latency, peer devices may communicate a connection status that is indicative of longer latency, such as TCP slow start status, which is assigned according to the TCP protocol under congestion or packet loss conditions occur. Recently, an enhancement to the TCP protocol has been proposed under the name of DCTCP, which utilizes fractional window adjustment based on the fraction of packets that are marked as not being properly transmitted, rather than halving the window upon detection of even one packet that is not transmitted properly as occurs in the TCP slow start protocol. When such enhancements to the TCP protocol are employed, other suitable congestion avoidance indicators, such as the connection status or window length of a fractionally slowed connection, may be communicated to the computing device and weighed in the selection of peer devices for use as gateways for outbound connections.

As another example, peer devices having a power status indicating a higher battery charge state and/or a plugged in external power connection state may be weighted for selection over peer devices having a lower battery charge state and/or an unplugged external power connection state. As another example, peer devices having a particular connection type (e.g., wireless or wired; 3G or 4G; higher guaranteed Quality of Service (QoS) or lower QoS, etc.) and/or a lower financial cost associated with communications may be weighted for selection over peer devices having a different connection type and/or a higher financial cost associated with communications. As yet another example, peer devices having a greater number of available peer device connections may be weighted for selection over peer devices having a lesser number of available peer device connections. As yet another example, peer devices having a greater processor and/or memory availability may be weighted for selection over peer devices having a lesser processor and/or memory availability. It is to be appreciated that these examples are non-limiting, and that status information may be utilized in combination for selection of peer devices in any suitable way.

In at least some implementations, all suitable and/or all available peer devices may be selected as gateways to the WAN, and requests may be distributed over all suitable and/or all available peer devices by the requesting computing device in a manner that maximizes bandwidth and minimizes latency of the total request stream for the computing device.

At 216, method 200 includes generating one or more requests for one or more network resources at the computing device. The one or more requests for the one or more network resources may be responsive to a user providing a user input at the computing device requesting the network resource. A network resource may include a webpage, a portion of a webpage, a file such as an image, a video, text, etc., a portion of a file, a computer program, or portion of a computer program, among other suitable network resources. In some implementations, each request may correspond to a respective network resource. However, in some implementations, two or more of the requests may be for different portions of the same network resource. As one example, the different portions of the same network resource may correspond to different byte ranges of the network resource.

At 218, method 200 includes sending the one or more requests to the one or more peer devices selected as gateways to be forwarded via the wide area network to one or more remote servers hosting the one or more network resources. The one or more requests may be sent by the computing device to the peer devices via wired and/or wireless communication links. The one or more requests received by the one or more peer devices may be forwarded to the one or more remote servers via wired and/or wireless communication links with one or more intermediate devices at or of the WAN. By sending a plurality of requests to a plurality of peer devices, network resources or portions thereof may be requested and received by the computing device in parallel via a number of peer devices. In at least some implementations, a peer device that receives requests from the computing device may forward the requests to one or more other peer devices (e.g., 2 or more peer devices, 10 or more peer devices, 20 or more peer devices, etc.) serving as gateways to the WAN. A request or request stream received by a peer device from the computing device may be broken into two or more requests or request streams, and may be forwarded to two or more other peer devices serving as gateways to the WAN.

At 220, method 200 includes receiving one or more responses to the one or more requests from the one or more remote servers via the one or more peer devices selected as gateways. At 220, method 200 may further include processing the one or more responses received from the one or more remote servers to obtain a combined data set including information contained in the one or more responses. As one example, the computing device may receive a plurality of network resources of a webpage, and may process the network resources to present the webpage to a user. As another example, the computing device may receive a plurality of byte ranges of a file, and may process the responses by combining the plurality of byte ranges to obtain the entire file. In at least some implementations, a peer device that receives responses or response streams from the WAN for a requesting computing device may forward the responses or response streams to one or more other peer devices for delivery to the computing device. Two or more responses or response streams received by a peer device may be combined into a common response or response stream, and may be forwarded to the requesting computing device via another peer device.

FIG. 3 is a flow diagram depicting another example method 300 for network communications via peer network connections according to one disclosed embodiment. As a non-limiting example, method 300 may be performed by example network communications system 100 of FIG. 1. Accordingly, method 300, or portions thereof may be implemented by one or more processors of one or more devices executing instructions. Method 300 may, for example, correspond to the method performed by the peer devices in method 200 of FIG. 2.

At 310, method 300 may include sending one or more of connection status information, power status information, and/or device status information from a computing device to one or more peer devices of a trusted group via a peer discovery local area network. The trusted group may be identified as previously described with reference to method 200 of FIG. 2. Alternatively or additionally, at 310, method 300 may include sending one or more of connection status information, power status information, and/or device status information from a computing device to a coordinating server via the WAN. As previously discussed, the coordinating sever may select the computing device (e.g., acting as a peer device to another peer device) as a gateway to the WAN for another peer device.

At 312, method 300 includes receiving a request at the computing device via the peer discovery local area network from the peer device to be forwarded by the computing device via the wide area network to a remote server. At 314, method 300 includes forwarding the request from the computing device to the remote server via the wide area network. At 316, method 300 includes receiving a response to the request at the computing device from the remote server via the wide area network. At 318, method 300 includes forwarding the response from the computing device to the peer device via the peer discovery local area network.

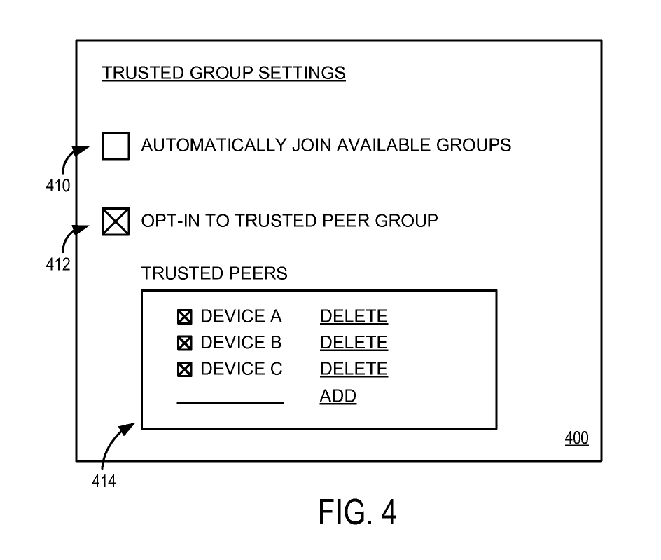

FIG. 4 is a schematic diagram depicting an example graphical user interface 400 of a computing device according to one disclosed embodiment. For example, graphical user interface (GUI) 400 may be presented via a display device of previously described computing device 110 of FIG. 1. GUI 400 includes a selector 410 to enable a user to select that the computing device automatically join (e.g., without necessarily requiring further user input) a trusted group by automatically joining available groups. GUI 400 includes a selector 412 to enable a user to select that the computing device join the trusted group by opting-in to joining. In response to a user selecting selector 412, the computing device may be configured to prompt the user to select whether they wish to join a trusted group of peer devices. GUI 400 may further include selectors 414 to enable a user to view a list of peer devices of a trusted group, delete peer devices from the trusted group, or add peer devices to the trusted group. User input received via GUI 400 may be used by the computing device to identify the trusted group of peer devices associated with the computing device.

FIG. 5 is a schematic diagram depicting a detailed view of an example computing device 500 according to one disclosed embodiment. Computing device 500 may correspond to one or more of the previously described computing device 110, peer devices 120-128, server devices 160 and 162, and/or coordinating server 170.

Computing device 500 may include one or more processors such as processor 510, a storage device 520, one or more input and/or output devices (I/O devices) 530, and one or more communications interfaces 540. I/O devices 530 may include one or more of a graphical display, keyboard, keypad, computer mouse, controller, touch-screen, audio speaker, audio microphone, or other suitable input and/or output device. Communications interfaces 540 may include one or more wireless and/or wired receivers, transmitters, transceivers, etc. supporting wired and/or wireless communications links for communications between peer devices and/or a WAN.

Storage device 520 may include or have instructions 522 and data store 524 stored thereon. Instructions 522 may be executable by processor 510 to perform one or more of the methods, processes, or functions described herein, including the methods of FIGS. 3 and 4, or portions thereof, for example. Instructions 522 may include a rule set 523 defining one or more rules which may be applied by computing device 500 responsive to status information obtained from peer devices to select one or more peer devices as gateways to a wide area network.

Data store 524 is depicted in greater detail including one or more device profiles 550, 560, 570, etc. Each device profile may include status information for a corresponding peer device of a trusted group, or may correspond to status information for computing device 500. The status information of each device profile may include one or more of connection status information, power status information, and/or device status information. For example, device profile 550 includes connection status information 552, power status information 554, and device status information 556. Device profile 560 includes connection status information 562, power status information 564, and device status information 566 for a different device than device profile 550. Device profile 570 includes connection status information 572, power status information 574, and device status information 576 for a different device than device profiles 550 and 560. Rule set 523 may be used by computing device 500 to select one or more peer devices of a trusted group as gateways to a WAN based, at least in part, on the status information contained in device profiles 550, 560, 570, etc.

It should be understood that the embodiments herein are illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

1. A method for network communications via peer network connections, the method comprising:
identifying a trusted group of peer devices associated with a computing device, the peer devices each being linked with the computing device via a peer discovery local area network;
receiving connection status information for each wide area network connection of each peer device of the trusted group;
selecting one or more peer devices from among the trusted group of peer devices as gateways to the wide area network based, at least in part, on the connection status information of each peer device of the trusted group, the connection status information for each peer device of the trusted group indicating a performance parameter of the wide area network connection;
generating one or more requests for one or more network resources at the computing device;
sending the one or more requests to the one or more peer devices selected as gateways to be forwarded via the wide area network to one or more remote servers hosting the one or more network resources, the performance parameter of each peer device of the trusted group including one or more of:
a round-trip time for communications between that peer device of the trusted group and a remote server of the one or more remote servers via the wide area network, and/or
an available bandwidth for communications between that peer device of the trusted group and the remote server via the wide area network; and
receiving one or more responses to the one or more requests from the one or more remote servers via the one or more peer devices selected as gateways.

2. (canceled)

3. (canceled)

4. The method of claim 1, wherein the connection status information for a wide area network connection of a peer device of the trusted group indicates a connection type of the wide area network connection.

5. The method of claim 1, wherein the connection status information for a wide area network connection of a peer device of the trusted group indicates a financial cost associated with communications between the peer device and a remote server of the one or more remote servers via the wide area network.

6. The method of claim 1, further comprising:
receiving connection status information for each peer discovery local area network connection between the computing device and each peer device of the trusted group; and
selecting the one or more peer devices of the trusted group as gateways to the wide area network further based, at least in part, on the connection status information for each peer discovery local area network connection.

7. The method of claim 1, further comprising:
balancing the one or more requests among the one or more peer devices selected as gateways.

8. The method of claim 1, further comprising:
processing the one or more responses received from the one or more remote servers to obtain a combined data set including information contained in the one or more responses.

9. The method of claim 1, wherein two or more of the requests are for different portions of the same network resource.

10. The method of claim 1, further comprising:
sending connection status information from the computing device to a peer device of the trusted group via the peer discovery local area network, the connection status information sent indicating a wide area network connection of the computing device;
receiving a request via the peer discovery local area network from the peer device to be forwarded via the wide area network to a remote server;
forwarding the request from the computing device to the remote server via the wide area network;
receiving a response to the request at the computing device from the remote server via the wide area network; and
forwarding the response from the computing device to the peer device via the peer discovery local area network.

11. The method of claim 1, further comprising:
receiving power status information of each peer device of the trusted group; and
selecting the one or more peer devices of the trusted group as gateways to the wide area network further based, at least in part, on the power status information of each peer device.

12. The method of claim 1, further comprising:
receiving device status information of each peer device of the trusted group; and
selecting the one or more peer devices of the trusted group as gateways to the wide area network further based, at least in part, on the device status information of each peer device.

13. The method of claim 1, wherein identifying the trusted group of peer devices associated with the computing device includes one or more of:
receiving via a selector displayed on a graphical user interface of the computing device, user input either to join the trusted group by opting-in to joining or to join the trusted group by automatically joining available groups; and/or
identifying a user account that spans each peer device of the trusted group.

14. A method for network communications via peer network connections, the method comprising:
identifying a trusted group of peer devices associated with a computing device, the peer devices each being linked with the computing device via a peer discovery local area network;
receiving power status information of each peer device of the trusted group, the power status information indicating a battery charge state and/or an external power connection state;
selecting one or more peer devices of the trusted group as gateways to the wide area network based, at least in part, on the power status information of each peer device;
generating one or more requests for one or more network resources at the computing device;
sending the one or more requests to the one or more peer devices selected as gateways to be forwarded via the wide area network to one or more remote servers hosting the one or more network resources; and
receiving one or more responses to the one or more requests from the one or more remote servers via the one or more peer devices selected as gateways.

15. (canceled)

16. The method of claim 14, further comprising:
receiving connection status information for each wide area network connection of each peer device; and
selecting the one or more peer devices of the trusted group as gateways to the wide area network further based, at least in part, on the connection status information of each peer device.

17. The method of claim 14, further comprising:
receiving device status information of each peer device of the trusted group; and
selecting the one or more peer devices of the trusted group as gateways to the wide area network further based, at least in part, on the device status information of each peer device.

18. The method of claim 14, wherein identifying the trusted group of peer devices associated with the computing device includes one or more of:
receiving via a selector displayed on a graphical user interface of the computing device, user input either to join the trusted group by opting-in to joining or to join the trusted group by automatically joining available groups; and/or
identifying a user account that spans each peer device of the trusted group.

19. A network communications system for network communications via peer network connections, comprising:
a computing device configured to:
identify a trusted group of peer devices associated with the computing device, the peer devices each being linked with the computing device via a peer discovery local area network;
receive connection status information for each wide area network connection of each peer device of the trusted group;
select one or more peer devices from among the trusted group of peer devices as gateways to the wide area network based, at least in part, on the connection status information of each peer device, the connection status information for each peer device of the trusted group indicating a performance parameter of the wide area network connection;
generate one or more requests for one or more network resources at the computing device;
send the one or more requests to the one or more peer devices selected as gateways to be forwarded via the wide area network to one or more remote servers hosting the one or more network resources, the performance parameter of each peer device of the trusted group including one or more of:
a round-trip time for communications between that peer device of the trusted group and a remote server of the one or more remote servers via the wide area network, and/or
an available bandwidth for communications between that peer device of the trusted group and the remote server via the wide area network; and
receive one or more responses to the one or more requests from the one or more remote servers via the one or more peer devices selected as gateways.

20. The network communications system of claim 19, wherein the computing device is further configured to:
receive power status information of each peer device of the trusted group, the power status information indicating a battery charge state and/or an external power connection state; and
select the one or more peer devices of the trusted group as gateways to the wide area network further based, at least in part, on the power status information of each peer device.

21. The method of claim 11, wherein the power status information indicates a battery charge state and/or an external power connection state.
